(19) United States
(12) Patent Application Publication
(10) Pub. No.: US 2014/0141342 A1
(43) Pub. Date: May 22, 2014

(54) ELECTROLYTE FOR LITHIUM SECONDARY BATTERY AND LITHIUM SECONDARY BATTERY INCLUDING SAME

(71) Applicants: Hyeong Kyu Lim, Gyeonggi-do (KR); Hong Hie Lee, Seoul (KR); Eun Gi Shim, Gyeonggi-do (KR); Jong Su Kim, Gyeonggi-do (KR); Chang Sin Lee, Gyeonggi-do (KR); Kyung Il Park, Gyeonggi-do (KR); Hahn Mok Song, Gyeonggi-do (KR)

(72) Inventors: Hyeong Kyu Lim, Gyeonggi-do (KR); Hong Hie Lee, Seoul (KR); Eun Gi Shim, Gyeonggi-do (KR); Jong Su Kim, Gyeonggi-do (KR); Chang Sin Lee, Gyeonggi-do (KR); Kyung Il Park, Gyeonggi-do (KR); Hahn Mok Song, Gyeonggi-do (KR)

(21) Appl. No.: 14/232,374

(22) PCT Filed: Jul. 12, 2012
(86) PCT No.: PCT/KR2012/005537

§ 371 Date: Jan. 13, 2014

(30) Foreign Application Priority Data
Jul. 12, 2011 (KR) 10-2011-0068751

(51) Int. Cl. H01M 10/0567; H01M 10/0525

(52) U.S. Cl. CPC H01M 10/0567; H01M 10/0525
USPC 429/331; 429/188; 429/199; 429/338; 429/342; 429/341; 429/326; 429/330; 429/332; 429/334

(57) ABSTRACT

The present invention relates to an electrolyte for a lithium secondary battery and a lithium secondary battery including the same, wherein the electrolyte comprises an organic solvent and an electrolyte additive, represented by chemical formula 1 and mixed lithium salts in the organic solvent so that room and high temperature life-time properties of the battery can be improved. Said chemical 1 is defined in the specification.

### BACKGROUND OF THE INVENTION

1. Field of the Invention

The present invention relates to an electrolyte for lithium secondary batteries that may enhance lifespan at room and high temperature of a lithium secondary battery and a lithium secondary battery including the same.

2. Description of the Related Art

In line with recent rapid development of electronic devices such as cellular phones, notebook computers, and the like, use of lithium secondary batteries with higher energy density and longer cycle lifespan than existing NiMH or NiCd batteries has been very rapidly increasing.

As such lithium secondary batteries are increasingly used, excellent characteristics such as high safety, excellent lifespan and high capacity of lithium secondary batteries are strongly required to secure device safety and user safety.

Lithium secondary batteries have an average discharge voltage of about 3.6 V to about 3.7 V and thus may obtain higher power than other alkali batteries, Ni—MH batteries, Ni—Cd batteries, and the like. However, in order for lithium secondary batteries to have such a high driving voltage, an electrolyte having an electrochemically stable composition at 0 V to 4.6 V, which is a charge/discharge voltage region, is needed.

In lithium secondary batteries, lithium ions migrate from a cathode to an anode and intercalate into the anode during initial charging. In this regard, Li reacts with the anode to produce Li₂CO₃, LiO, LiOH, or the like and, accordingly, a film is formed on a surface of the anode. Such a film is referred to as a solid electrolyte interface (SEI) film.

The SEI film formed in an initial stage of charging prevents reaction between lithium ions and an anode or other materials during charge and discharge. In addition, the SEI film serves as an ion tunnel and allows only lithium ions to pass.

The ion tunnel solvates lithium ions and thus prevents a structure of a anode from collapsing due to cointercalation of organic solvents flowing along with the lithium ions and having a great molecular weight of an electrolyte into a carbon anode, and prevents side reaction between lithium ions and other materials.

To enhance storage and stability of batteries, it is necessary to stably form an SEI film and a method of enhancing stability, lifespan characteristics and capacity of batteries is needed.

Thus, conventionally, vinylene carbonate, 1,3-propanesultone, or the like is used as an electrolyte additive. However, the electrolyte additive is insufficient to enhance stability, lifespan characteristics and capacity of batteries to a desired level.

### SUMMARY OF THE INVENTION

Therefore, the present invention has been made in view of the above problems, and it is an object of the present invention to provide an electrolyte for lithium secondary batteries that may enhance lifespan characteristics at room and high temperature of a lithium secondary battery.

It is another object of the present invention to provide a lithium secondary battery including the above-described electrolyte.

In accordance with an aspect of the present invention, the above and other objects can be accomplished by the provision of an electrolyte for lithium secondary batteries, including an organic solvent, a lithium salt mixed with the organic solvent, and an electrolyte additive mixed with the organic solvent and represented by Formula 1 below:

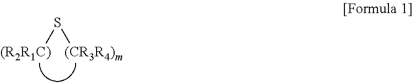

wherein R₁ to R₄ are each independently selected from the group consisting of hydrogen, a C₁-C₅ alkyl group, a C₁-C₅ perfluoroalkyl group, a C₃-C₆ cycloalkyl group, a C₂-C₅ alkenyl group, a C₂-C₅ alkynyl group, an allyl group, an alkoxy group, an alkoxyalkyl group, a silyl group, an alkylsilyl group, and a cyano group, and

m is an integer of 1 to 4.

R₁ and R₃ may each independently be any one selected from the group consisting of a C₁-C₅ alkanediyl group and a C₁-C₅ alkenediyl group, and R₁ and R₃ may be linked to each other to form a four- to ten-membered alicyclic ring.

The electrolyte additive may be any one selected from the group consisting of ethylene sulfide, propylene sulfide, 2-vinylthiirane, 2,3-epithiopropyl methyl ether, 2-(trimethylsilyl)-thiirane, 2,3-di(trimethylsilyl)-thiirane, 1-cyano-3,4-epithiobutane, isobutylene sulfide, cyclohexene sulfide, and mixtures thereof.

An amount of the electrolyte additive may be 0.1 wt % to 5 wt % based on a total weight of the electrolyte.

The organic solvent may be any one selected from the group consisting of ethylene carbonate (EC), propylene carbonate (PC), ethyl methyl carbonate (EMC), dimethyl carbonate (DMC), diethyl carbonate (DEC), fluoroethylene carbonate (FEC), methyl propyl carbonate (MPC), ethyl propyl carbonate (EPC), methyl ethyl carbonate (MEC), butylene carbonate (BC), ethyl acetate, methyl acetate, propyl acetate, ethyl propionate, methyl propionate, propyl propionate, and mixtures thereof.

The lithium salt may be selected from the group consisting of LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiN(CₓF₂ₓ₊₁SO₂)(C_{y}F_{2y+1}SO₂) where x and y are natural numbers, LiCl, LiI, and mixtures thereof.

The electrolyte may further include an additive selected from the group consisting of vinylene carbonate, 1,3-propanesultone, metal fluoride, glutaronitrile, succinonitrile, adiponitrile, 3,3′-thiodipropiodinitrile, propene sultone, lithium bis(oxalato)borate, vinyl ethylene carbonate, and mixtures thereof.

In accordance with another aspect of the present invention, there is provided a lithium secondary battery including a cathode including a cathode active material, an anode including an anode active material and facing the cathode, and the electrolyte disposed between the cathode and the anode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a lithium secondary battery according to an embodiment of the present invention;

FIG. 2 is a graph showing results of interfacial reaction between an electrolyte additive and an anode of each of the batteries (E1-i to E1-4) manufactured according to Comparative Examples 1 and 2 and Examples 1 and 2;

FIG. 3 is a graph showing lifespan at room temperature (25° C.) of each of the batteries (E1-i to E1-4) of Comparative Examples 1 and 2 and Examples 1 and 2;

FIG. 4 is a graph showing lifespan at high temperature (45° C.) of each of the batteries (E1-i to E1-4) of Comparative Examples 1 and 2 and Examples 1 and 2;

FIG. 5 is a graph showing lifespan at high temperature (45° C.) of each of the lithium secondary batteries (E2-1 to E2-6) according to kinds of electrolyte additives;

FIG. 6 is a graph showing lifespan at high temperature (45° C.) of each of the lithium secondary batteries (E3-1 to E3-6) according to amount of an electrolyte additive;

FIG. 7 is a graph showing lifespan at low temperature (25° C.) of each of the lithium secondary batteries (E4-1 to E4-10) according to kinds of electrolyte additives; and

FIG. 8 is a graph showing lifespan at high temperature (60° C.) of each of the lithium secondary batteries (E5-1 to E5-8) according to kinds of electrolyte additives.

### DESCRIPTION OF SYMBOLS

1: lithium secondary battery
3: anode, 5: cathode
7: separator, 9: electrode assembly
10, 13: conductive lead members, 15: case

### DETAILED DESCRIPTION OF THE INVENTION

Hereinafter, embodiments of the present invention will be described in detail.

Terms used herein are defined as follows.

The term “alkyl” as used herein includes primary alkyl, secondary alkyl, and tertiary alkyl, unless otherwise stated herein. Examples of “alkyl” used herein include, without being limited to, methyl, ethyl, n-propyl, isopropyl, n-butyl, iso-butyl, t-butyl, n-pentyl, isopentyl, and hexyl.

The term “cycloalkyl” as used herein includes monocyclic, bicyclic, tricyclic, and tetracyclic, unless otherwise stated herein. Herein, “cycloalkyl” includes a polycyclic cycloalkyl group including an adamantyl group and a norbornyl group.

The term “alkenyl” as used herein means a linear or branched hydrocarbon radical chain having at least one carbon-carbon double bond, unless otherwise stated herein. Examples of “alkenyl” used herein include, without being limited to, ethenyl and propenyl.

The term “alkynyl” as used herein means a linear or branched, saturated hydrocarbon radical chain having at least one carbon-carbon triple bond, unless otherwise stated herein. Examples of “alkynyl” used herein include, without being limited to, acetylenyl and 1-propynyl.

The term “alkanediyl” as used herein represents a divalent atomic group obtained by subtracting two hydrogen atoms from an alkane, unless otherwise stated herein, and may be represented by the general formula —CₙH₂ₙ—. The term “alkenediyl” as used herein represents a divalent atomic group obtained by subtracting two hydrogen atoms from an alkene, unless otherwise stated herein, and may be represented by the general formula —CₙHₙ—.

Unless otherwise stated herein, the term “alkoxy” as used herein means an —ORa group, wherein Ra is alkyl defined as above. Examples of “alkoxy” used herein include, without being limited to, methoxy, difluoromethoxy, trifluoromethoxy, ethoxy, n-propoxy, isopropoxy, n-butoxy, and t-butoxy.

Unless otherwise stated herein, the term “alkoxyalkyl” as used herein means an —ORbRc group, wherein Rb and Rc represent alkyl defined as above. Examples of “alkoxyalkyl” used herein include, without being limited to, methoxymethyl, ethoxymethyl, n-propoxymethyl, isopropoxymethyl, n-butoxyethyl, and t-butoxyethyl.

Unless otherwise stated herein, the term “alkylsilyl” as used herein means —SiH₂Rd, —SiHReRf, or —SiRgRhRi, wherein Rd to Ri represent alkyl defined as above. Examples of “alkylsilyl” used herein include, without being limited to, methylsilyl, ethylsilyl, and isopropylsilyl.

All the compounds or substituents as used herein may be substituted or unsubstituted unless otherwise stated herein. In this regard, the term “substituted” means that a hydrogen atom is substituted with any one selected from the group consisting of a halogen atom, a hydroxyl group, a carboxyl group, a cyano group, a nitro group, an amino group, a thio group, a methylthio group, an alkoxy group, a nitrile group, an aldehyde group, an epoxy group, an ether group, an ester group, a carbonyl group, an acetal group, a ketone group, an alkyl group, a cycloalkyl group, a heterocycloalkyl group, an allyl group, a benzyl group, an aryl group, a heteroaryl group, derivatives thereof, and combinations thereof.

According to an embodiment of the present invention, an electrolyte for lithium secondary batteries includes: an organic solvent; a lithium salt mixed with the organic solvent; and an electrolyte additive mixed with the organic solvent and represented by Formula 1 below:

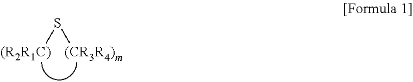

wherein R₁ to R₄ are each independently any one selected from the group consisting of hydrogen, a C₁-C₅ alkyl group, a C₁-C₅ perfluoroalkyl group, a C₃-C₆ cycloalkyl group, a C₂-C₅ alkenyl group, a C₂-C₅ alkynyl group, an allyl group, an alkoxy group, an alkoxyalkyl group, a silyl group, an alkylsilyl group, and a cyano group.

In Formula 1, m is an integer of 1 to 4.

In addition, the R₁ and R₃ groups may be linked to each other to form a four- to ten-membered alicyclic ring. In this regard, R₁ and R₃ may each independently be any one selected from the group consisting of a C₁-C₅ alkanediyl group and a C₁-C₅ alkenediyl group.

Preferably, R₁ to R₄ may each independently be any one selected from the group consisting of hydrogen, a methyl group, and an ethyl group, the R₁ and R₃ groups may be linked to each other to form a six-membered cyclohexyl group, and m may be an integer of 1 or 2.

In particular, the electrolyte additive may be any one selected from the group consisting of ethylene sulfide, propylene sulfide, 2-vinylthiirane, 2,3-epithiopropyl methyl ether, 2-(trimethylsilyl)-thiirane, 2,3-di(trimethylsilyl)-thiirane, 1-cyano-3,4-epithiobutane, isobutylene sulfide, cyclohexene sulfide, and mixtures thereof.

The electrolyte additive decomposes before the organic solvent included in the electrolyte during discharge of a battery at room and high temperature and thus effectively and stably forms a solid electrolyte interface (SEI) film and, accordingly, lithium ions may be easily intercalated into a surface of an electrode. As a result, lifespan of a battery at room and high temperature may be enhanced.

The amount of the electrolyte additive may be between 0.1 and 5 wt %, preferably between 0.1 and 2 wt %, based on a total weight of the electrolyte.

When the amount of the electrolyte additive is less than 0.1 wt % based on the total weight of the electrolyte, effects of the electrolyte additive may be insignificant. On the other hand, when the amount of the electrolyte additive exceeds 5 wt % based on the total weight of the electrolyte, increasing effects of charge and discharge efficiencies may be insignificant due to impurities produced by side reaction between the electrolyte additive and the electrolyte and lifespan performance may be deteriorated.

The organic solvent may be any organic solvent that serves as a medium through which ions involved in electrochemical reaction of a battery migrate. In particular, the organic solvent may be any one selected from the group consisting of an ester solvent, an ether solvent, a ketone solvent, an aromatic hydrocarbon solvent, a propionate solvent, a carbonate solvent, and combinations thereof.

The ester solvent may be n-methyl acetate, n-ethyl acetate, n-propyl acetate, or the like. The ether solvent may be dibutyl ether, tetraglyme, 2-methyltetrahydrofuran, tetrahydrofuran, or the like. The ketone solvent may be cyclohexanone or the like.

The aromatic hydrocarbon solvent may be benzene, fluorobenzene, chlorobenzene, iodobenzene, toluene, fluorotoluene, xylene, or a mixture thereof.

The propionate solvent may be ethyl propionate, methyl propionate, propyl propionate, or the like.

The carbonate solvent may be dimethylcarbonate (DMC), diethylcarbonate (DEC), dipropylcarbonate (DPC), methylpropylcarbonate (MPC), ethylpropylcarbonate (EPC), methylethylcarbonate (MEC), ethylmethylcarbonate (EMC), ethylene carbonate (EC), propylene carbonate (PC), butylene carbonate (BC), fluoroethylene carbonate (FEC), or a mixture thereof.

The organic solvent may be a carbonate solvent. More preferably, a mixed solvent having appropriate viscosity and high permittivity, prepared by mixing a high permittivity solvent having high ionic conductivity so as to enhance charge and discharge performance of a battery and an organic solvent with low viscosity so as to appropriately adjust the viscosity of the high permittivity solvent, may be used as the organic solvent. In particular, a solvent prepared by mixing any one selected from the group consisting of ethylene carbonate, propylene carbonate, and mixtures thereof and any one selected from the group consisting of ethylmethylcarbonate, dimethylcarbonate, diethylcarbonate, and mixtures thereof may be used as the organic solvent.

The lithium salt may be any compound that provides lithium ions used in a lithium secondary battery and may, for example, be any one selected from the group consisting of LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂. LiN(CₓF₂ₓ₊₁SO₂)(C_{y}F_{2y+1}SO₂) where x and y are natural numbers, LiCl, LiI, and mixtures thereof. Preferably, the lithium salt may be lithium hexafluorophosphate (LiPF₆).

When the lithium salt is included in the electrolyte, the lithium salt is dissolved in the electrolyte and thus serves as a source of lithium ions in a battery and may accelerate migration of lithium ions between a cathode and an anode.

The concentration of the lithium salt in the electrolyte may be between 0.6 and 2 moles, preferably between 0.7 and 1.6 moles. When the concentration of the lithium salt is less than 0.6 moles, conductivity of the electrolyte decreases and thus performance of the electrolyte may be deteriorated. On the other hand, when the concentration of the electrolyte exceeds 2 moles, the viscosity of the electrolyte increases and thus mobility of lithium ions may be decreased.

The electrolyte may further include an additive (hereinafter referred to as “additional additive”) that may be generally included in an electrolyte to enhance lifespan of a battery, inhibit reduction in capacity of a battery, and increase discharge capacity of a battery, in addition to the above-described electrolyte additive.

In particular, the additional additive may be selected from the group consisting of vinylene carbonate (VC), metal fluorides (e.g., LiF, RbF, TiF, AgF, AgF₂, BaF₂, CaF₂, CdF₂, FeF₂, HgF₂, Hg₂F₂, MnF₂, NiF₂, PbF₂, SnF₂, SrF₂, XeF₂, ZnF₂, AlF₃, BF₃, BiF₃, CeF₃, CrF₃, DyF₃, EuF₃, GaF₃, GdF₃, FeF₃, HoF₃, InF₃, LaF₃, LuF₃, MnF₃, NdF₃, PrF₃, SbF₃, ScF₃, SmF₃, TbF₃, TiF₃, TmF₃, YF₃, YbF₃, TIF₃, CeF₄, GeF₄, HfF₄, SiF₄, SnF₄, TiF₄, VF₄, ZrF4₄, NbF₅, SbF₅, TaF₅, BiF₅, MoF₆, ReF₆, SF₆, WF₆, CoF₂, CoF₃, CrF₂, CsF, ErF₃, PF₃, PbF₃, PbF₄, ThF₄, TaF₅, SeF₆, and the like), glutaronitrile (GN), succinonitrile (SN), adiponitrile (AN), 3,3′-thiodipropiodinitrile (TPN), 1,3-propane sultone (PS), propene sultone (PRS), lithium bis(oxalato)borate (LIBOB), vinylethylene carbonate (VEC), and mixtures thereof.

The amount of the additional additive may be 0.1 wt % to 5 wt % based on a total weight of the organic solvent.

The electrolyte having the above-described composition according to the present invention may have high stability at a temperature ranging from −20° C. to 60° C. and be electrochemically stable even at a voltage of about 4 V and thus, when being applied to a lithium secondary battery, the electrolyte may increase lifespan of the lithium secondary battery.

Lithium secondary batteries may be classified as a lithium ion battery, a lithium ion polymer battery, and a lithium polymer battery according to kinds of separator and electrolyte used, lithium secondary batteries may be classified as a cylindrical type, a rectangular type, a coin type, and a pouch type according to shape thereof, and lithium secondary batteries may be classified as a bulk type and a thin film type according to size thereof. The electrolyte according to the present invention may be suitable for use in, in particular, a lithium ion battery, an Al-stacked battery, and a lithium polymer battery.

A lithium secondary battery according to another embodiment of the present invention includes a cathode including a cathode active material, an anode including an anode active material and facing the cathode, and the electrolyte disposed between the cathode and the anode.

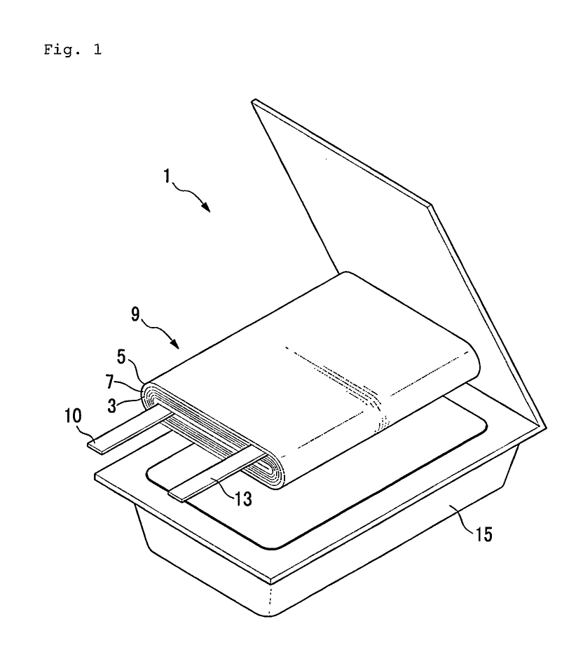

FIG. 1 is an exploded perspective view of a lithium secondary battery 1 according to an embodiment of the present invention. Although FIG. 1 illustrates a pouch-type lithium secondary battery, the shape of the lithium secondary battery according to the present invention is not limited to the above example. That is, the lithium secondary battery may have any shape so long as it acts as a battery.

Referring to FIG. 1, the lithium secondary battery 1 is manufactured by fabricating an electrode assembly 9 including an anode 3, a cathode 5, and a separator 7 disposed between the anode 3 and the cathode 5, placing the electrode assembly 9 in a case 15, and injecting a non-aqueous electrolyte thereinto so as to impregnate the anode 3, the cathode 5, and the separator 7 with the non-aqueous electrolyte.

Conductive lead members 10 and 13 to collect current generated when a battery operates may be respectively attached to the anode 3 and the cathode 5, and the conductive lead members 10 and 13 may respectively induce current generated from the anode 3 and the cathode 5 to anode and cathode terminals.

The cathode 5 may be manufactured by preparing a composition for forming a cathode active material layer by mixing a cathode active material, a conductive agent, and a binder, coating the composition on a cathode current collector such as an Al foil or the like, and rolling the coated cathode current collector.

As the cathode active material, a compound enabling reversible intercalation and deintercalation of lithium (lithiated intercalation compound) may be used. In particular, an olivine type compound represented by Formula 2 below may be used.

LiₓM_{y}M′_{z}XO_{4-w}B_{w} [Formula 2]

In Formula 2, M and M′ are each independently an element selected from the group consisting of Fe, Ni, Co, Mn, Cr, Zr, Nb, Cu, V, Mo, Ti, Zn, Al, Ga, Mg, B, and combinations thereof, X is an element selected from the group consisting of P, As, Bi, Sb, Mo, and combinations thereof, B is an element selected from the group consisting of F, S, and combinations thereof, 0<x≦1, 0<y≦1, 0<z≦1, 0<x+y+z≦2, and 0≦w≦0.5.

The cathode active material may be any one lithium metal oxide selected from the group consisting of LiCoO₂, LiMnO₂, LiMn₂O₄, LiNiO₂, LiNiₓMn₍₁₋ₓ₎O₂ where 0<x<1, LiM₁ₓM_{2y}O₂ where 0≦x≦1, 0≦y≦1, 0≦x+y≦1, and M₁ and M₂ are each independently any one selected from the group consisting of Al, Sr, Mg, and La, and combinations thereof.

When a lithium metal oxide is used as the cathode active material, a battery may have high capacity and high stability.

As in the cathode 5, the anode 3 may be manufactured by preparing a composition for forming an anode active material layer by mixing an anode active material, a binder, and, optionally, a conductive agent and coating the composition onto an anode current collector such as a Cu foil or the like.

As the anode active material, a compound enabling reversible intercalation and deintercalation of lithium may be used. In particular, the anode active material may be a carbonaceous material such as artificial graphite, natural graphite, graphitized carbon fiber, amorphous carbon, or the like. In addition, in addition to the carbonaceous material, a metallic compound alloyable with lithium or a composite including a metallic compound and a carbonaceous material may also be used as the anode active material.

A metal alloyable with lithium may, for example, be Si, Al, Sn, Pb, Zn, Bi, In, Mg, Ga, Cd, an Si alloy, an Sn alloy, an Al alloy, or the like. In addition, a metal lithium thin film may also be used as the anode active material.

The anode active material may be any one selected from the group consisting of crystalline carbon, amorphous carbon, a carbon composite, lithium metal, a Li-containing alloy, and combinations thereof, in terms of high stability.

The cathode 5 may be fabricated by coating a mixture of LiCoO₂ as a cathode active material, carbon black as a conductive agent, polyvinylidene fluoride (PVDF) as a binder, and n-methyl-2-pyrrolidone (NMP) as a solvent on an Al substrate. The anode 3 may be fabricated by coating a slurry including mesocarbon microbeads (MCMBs) as artificial graphite, carbon black, polyvinylidene fluoride (PVDF) as a binder, and n-methyl-2-pyrrolidone (NMP) as a solvent on a Cu substrate.

The electrolyte has already been described above and thus a detailed description thereof will be omitted herein.

The lithium secondary battery may be manufactured using a commonly used method, and the lithium secondary battery manufactured using the electrolyte including the electrolyte additive has excellent lifespan at room and high temperature.

Hereinafter, embodiments of the present invention will be more fully described with reference to the accompanying examples so that the present invention may be easily carried out by those skilled in the art to which the present invention pertains. However, the present invention may be embodied in various different forms and should not be construed as limiting the scope and spirit of the present invention.

Preparation Example of Electrolyte and Manufacture Example of Lithium Secondary Battery

Hereinafter, ethylene carbonate is abbreviated as EC, ethyl methyl carbonate as EMC, diethylene carbonate as DEC, 1,3-propanesultone as PS, propene sultone as PRS, fluoroethylene carbonate as FEC, and vinylene carbonate as VC.

A cathode was fabricated by coating a mixture of LiCoO₂ as a cathode active material, carbon black as a conductive agent, polyvinylidene fluoride (PVDF) as a binder, and n-methyl-2-pyrrolidone (NMP) as a solvent on an Al substrate. In addition, an anode was fabricated by coating a slurry including mesocarbon microbeads (MCMBs) as artificial graphite, carbon black, polyvinylidene fluoride (PVDF) as a binder, and n-methyl-2-pyrrolidone (NMP) as a solvent on a Cu substrate.

The term “%” as used herein, related to amount, denotes wt %.

### Comparative Example 1

An electrolyte was prepared by adding 1M LiPF₆ to a mixed solution of EC, EMC, and DEC (weight ratio of EC/EMC/DEC=1/1/1). Manufacture of an Al-pouch type lithium secondary battery (hereinafter referred to as “E1-1”) was completed using the prepared electrolyte, the cathode, and the anode.

### Comparative Example 2

A lithium secondary battery (hereinafter referred to as “E1-2”) was manufactured in the same manner as in Comparative Example 1, except that 1 wt % of 1,3-propanesultone was added to the mixed solution of EC/EMC/DEC in preparation of the electrolyte.

### Example 1

A lithium secondary battery (hereinafter referred to as “E1-3”) was manufactured in the same manner as in Comparative Example 1, except that 1 wt % of propylene sulfide was added to the mixed solution of EC/EMC/DEC in preparation of the electrolyte.

### Example 2

A lithium secondary battery (referred to as “E1-4”) was manufactured in the same manner as in Comparative Example 1, except that 2 wt % of propylene sulfide was added to the mixed solution of EC/EMC/DEC in preparation of the electrolyte.

Evaluation of Physical Properties of Lithium Secondary Battery

1. Evaluation of Interfacial Reaction of Additive and Anode

E1-i, E1-2, E1-3, and E1-4 respectively manufactured according to Comparative Examples 1 and 2 and Examples 1 and 2 were charged at a current of 230 mA (0.1 C) and 4.2 V (cut-off 0.02 C) under conditions of constant current (CC)/constant voltage (CV), and interfacial reaction between an additive and an anode during charge was evaluated.

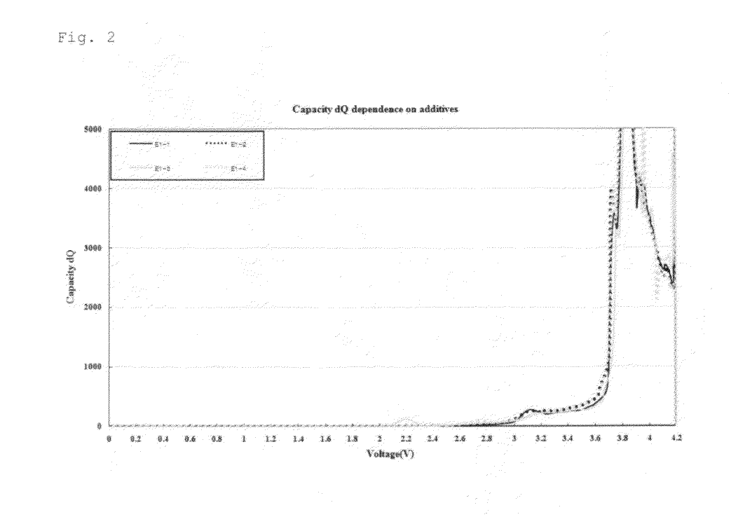

Evaluation results are shown in FIG. 2.

As illustrated in FIG. 2, an SEI film was formed in E1-3 of Example 1 and E1-4 of Example 2 including propylenesulfide before an SEI film is formed in E1-i of Comparative Example 1 and E1-2 of Comparative Example 2.

2. Evaluation of Lifespan at Room and High Temperature

E1-1, E1-2, E1-3, and E1-4 respectively manufactured according to Comparative Examples 1 and 2 and Examples 1 and 2 were charged at a current of 2300 mA and 4.2 V (cut-off 0.02 C) under conditions of CC/CV and discharged at a current of 2300 mA until voltage reached 3.0 V. Lifespan (cycle performance) of each battery was measured by repeating this process 300 times.

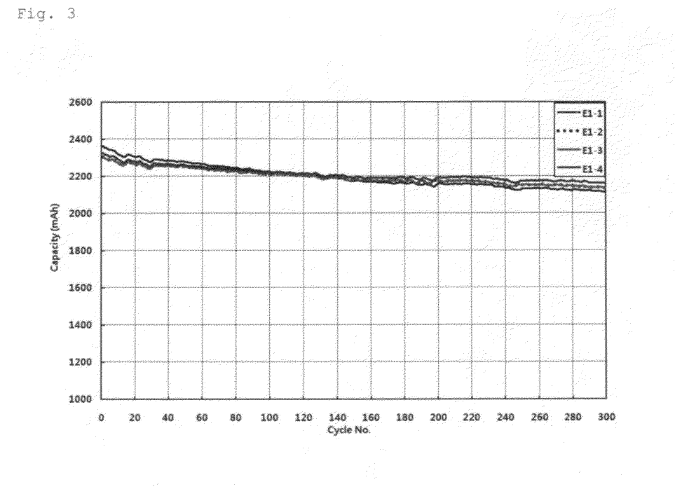

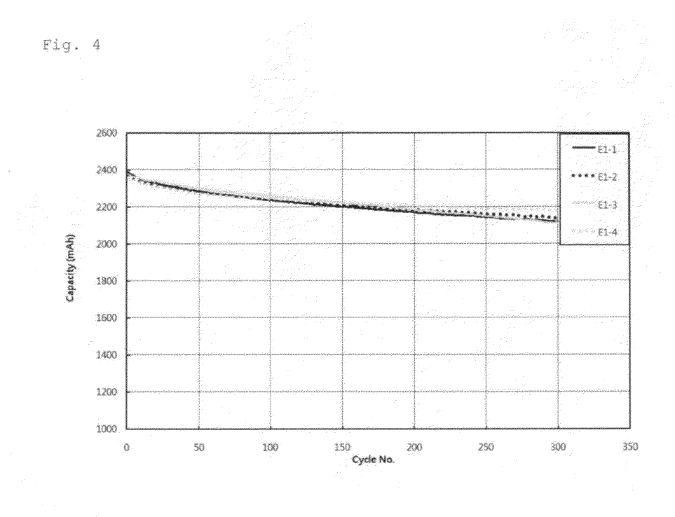

Cycle performance evaluation results at room temperature (25° C.) and high temperature (45° C.) are shown in Tables 1 and 2 below and FIGS. 3 and 4.

TABLE 1

| | | 1^{st} cycle | 300^{th} cycle | Efficiency |
|---|---|---|---|---|
| | | (mAh) | (mAh) | (%) |
| Lifespan at | Comparative | 2362.7 | 2116.6 | 89.6 |
| room | Example 1 (E1-1) | | | |
| temperature | | | | |
| | Comparative | 2315.1 | 2125.1 | 91.8 |
| | Example 2 (E1-2) | | | |
| | Example 1 (E1-3) | 2303.5 | 2136.6 | 92.8 |
| | Example 2 (E1-4) | 2325.5 | 2161.0 | 92.9 |

TABLE 2

| | | 1^{st} cycle | 300^{th} cycle | Efficiency |
|---|---|---|---|---|
| | | (mAh) | (mAh) | (%) |
| Lifespan at | Comparative | 2387.9 | 2119.5 | 88.8 |
| high | Example 1 (E1-1) | | | |
| temperature | | | | |
| | Comparative | 2366.6 | 2141.3 | 90.5 |
| | Example 2 (E1-2) | | | |
| | Example 1 (E1-3) | 2380.0 | 2115.3 | 89.0 |
| | Example 2 (E1-4) | 2360.5 | 2180.1 | 92.4 |

Referring to Tables 1 and 2, E1-3 of Example 1 and E1-4 of Example 2 exhibited superior lifespan at room and high temperature, in particular high temperature, to those of E1-1 of Comparative Example 1 and E1-2 of Comparative Example 2.

3. Evaluation of Lifespan at High Temperature According to Kinds of Additives

1M LiPF₆ was added to a mixed solution of EC and EMC (weight ratio of EC/EMC=3/7), and various different additives as shown in the following table were added thereto, thereby completing preparation of electrolytes. Lithium secondary batteries were manufactured in the same manner as in Example 1, except that the prepared electrolytes were used.

Each of the manufactured batteries (E2-1 to E2-6) was charged at a current of 910 mA and 1.0 C/4.2 V (cut-off 0.02 C) under conditions of CC/CV and discharged at a current of 910 mA and a CC of 1.0 C until voltage reached 2.7 V. Lifespan (cycle performance) of each battery was measured by repeating this process 300 times.

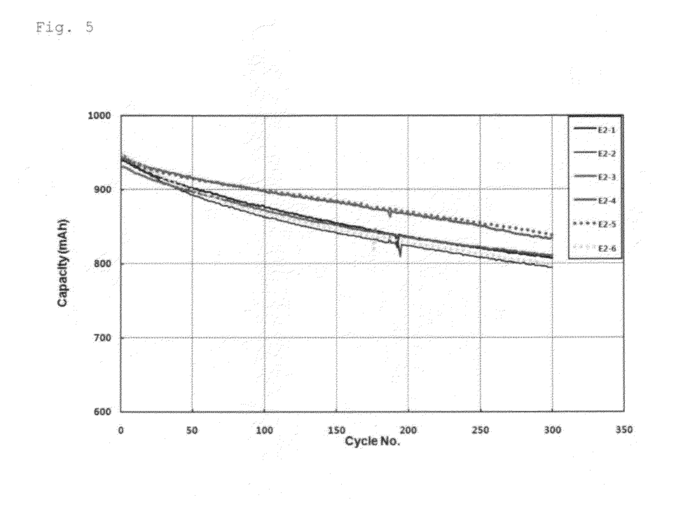

The cycle performance of each battery was evaluated at high temperature (45° C.) and evaluation results are shown in Table 3 below and FIG. 5.

TABLE 3

| | Battery | Additives | 1^{st} cycle | 300^{th} cycle | Efficiency |
|---|---|---|---|---|---|
| | No. | (amount) | (mAh) | (mAh) | (%) |
| Comparative | E2-1 | — | 939.5 | 807.3 | 85.9 |
| Example | | | | | |
| | E2-2 | PS (1%) | 947.1 | 794.5 | 83.9 |
| | E2-3 | VC (1%) | 930.5 | 810.7 | 87.1 |
| Example | E2-4 | Propylene | 942.3 | 833.6 | 88.5 |
| | | sulfide (1%) | | | |
| | E2-5 | VC (1%) + | 942.6 | 838.7 | 89.0 |
| | | propylene | | | |
| | | sulfide (1%) | | | |
| | E2-6 | PS (1%) + | 947.4 | 799.9 | 84.4 |
| | | propylene | | | |
| | | sulfide (1%) | | | |

Referring to Table 3, E2-4 of Example including propylene sulfide exhibited superior lifespan at high temperature to that of E2-1 of Comparative Example excluding an electrolyte additive. In addition, E2-5 and E2-6 of Examples including propylene sulfide along with a general electrolyte additive exhibited superior lifespan at high temperature to those of E2-2 and E2-3 of Comparative Examples including a general electrolyte additive alone.

4. Evaluation of Lifespan at High Temperature According to Amount of Additive

1M LiPF₆ was added to a mixed solution of EC, EMC, and DEC (weight ratio of EC/EMC/DEC=1/1/1), and propylene sulfide was added thereto by varying the amount of propylene sulfide as shown in the following table, thereby completing preparation of electrolytes. Lithium secondary batteries were manufactured in the same manner as in Example 1, except that the prepared electrolytes were used.

Each of the manufactured batteries (E3-1 to E3-6) was charged at a current of 910 mA and 1.0 C/4.2 V (cut-off 0.02 C) under conditions of CC/CV and discharged at a current of 910 mA and a CC of 1.0 C until voltage reached 2.7 V. Lifespan (cycle performance) of each battery was measured by repeating this process 100 times.

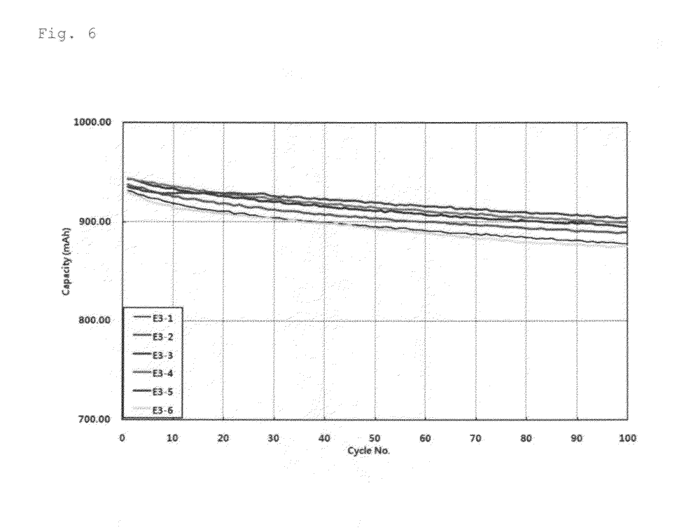

The cycle performance of each battery was evaluated at high temperature (45° C.) and evaluation results are shown in Table 4 below and FIG. 6.

TABLE 4

| High- | | | | | |
|---|---|---|---|---|---|
| temperature | Battery | | 1^{st} cycle | 100^{th} cycle | Efficiency |
| lifespan | No. | Amount | (mAh) | (mAh) | (%) |
| | E3-1 | 0 (%) | 931.6 | 878.0 | 94.2 |
| | E3-2 | 0.2 (%) | 937.5 | 888.8 | 94.8 |
| | E3-3 | 0.5 (%) | 943.0 | 894.8 | 94.9 |
| | E3-4 | 1 (%) | 943.4 | 898.9 | 95.3 |
| | E3-5 | 2 (%) | 935.3 | 904.0 | 96.7 |
| | E3-6 | 3 (%) | 929.0 | 874.8 | 94.2 |

Referring to Table 4, it can be confirmed that lifespan of each battery at high temperature is enhanced as the amount of propylene sulfide increases in cases in which the amounts of propylene sulfide are 0 wt %, 0.2 wt %, 0.5 wt %, 1 wt %, and 2 wt %.

5. Evaluation of Lifespan at Room Temperature According to Kinds of Additives

1M LiPF₆ was added to a mixed solution of EC and EMC (weight ratio of EC/EMC=3/7), and various different additives as shown in the following table were added thereto, thereby completing preparation of electrolytes. Lithium secondary batteries were manufactured in the same manner as in Example 1, except that the prepared electrolytes were used.

Each of the manufactured batteries (E4-1 to E4-10) was charged at a current of 910 mA and 1.0 C/4.2 V (cut-off 0.02 C) under conditions of CC/CV and discharged at a current of 910 mA and a CC of 1.0 C until voltage reached 2.7 V. Lifespan (cycle performance) of each battery was measured by repeating this process 100 times.

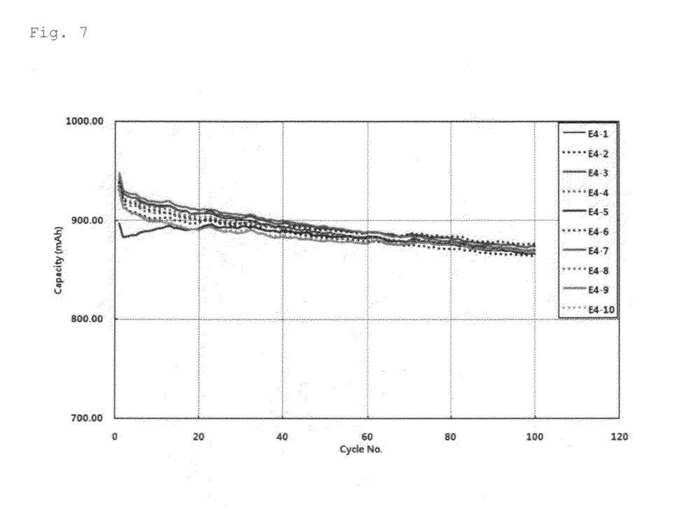

The cycle performance of each battery was evaluated at room temperature (25° C.) and evaluation results are shown in Table 5 below and FIG. 7.

TABLE 5

| Room | | | 1^{st} | 100^{th} | Effi- |
|---|---|---|---|---|---|
| temperature | Battery | Additive | cycle | cycle | ciency |
| lifespan | No. | (wt %) | (mAh) | (mAh) | (%) |
| | E4-1 | — | 945.3 | 866.3 | 91.6 |
| | E4-2 | FEC (1) | 937.7 | 864.1 | 92.2 |
| | E4-3 | Ethylene sulfide (1) | 944.6 | 873.9 | 92.5 |
| | E4-4 | Ethylene sulfide | 934.8 | 869.1 | 93.0 |
| | | (1) + FEC (1) | | | |
| | E4-5 | Isobutylene sulfide | 897.0 | 870.1 | 97.0 |
| | | (1) | | | |
| | E4-6 | Isobutylene sulfide | 930.7 | 876.2 | 94.1 |
| | | (1) + FEC (1) | | | |
| | E4-7 | Cyclohexene sulfide | 948.1 | 869.5 | 91.7 |
| | | (1) | | | |
| | E4-8 | Cyclohexene sulfide | 940.3 | 868.1 | 92.3 |
| | | (1) + FEC (1) | | | |
| | E4-9 | Propylene sulfide | 932.5 | 868.6 | 93.1 |
| | | (1) | | | |
| | E4-10 | Propylene sulfide | 933.1 | 870.9 | 93.3 |
| | | (1) + FEC (1) | | | |

Referring to Table 5, it can be confirmed that the batteries (E4-3 to E4-10) of Examples including additives have higher efficiency than that of the battery (E4-1) excluding an additive and the battery (E4-2) including a conventional additive.

In addition, it can be confirmed that the batteries (E4-4, E4-6, E4-8, and E4-10) including FEC and the additives of the present invention have higher efficiency than that of the battery (E4-2) including FEC alone.

6. Evaluation of Lifespan at High Temperature According to Kinds of Additives

1M LiPF₆ was added to a mixed solution of EC, EMC, and DEC (weight ratio of EC/EMC/DEC=1/1/1), and various different additives as shown in the following table were added thereto, thereby completing preparation of electrolytes. Lithium secondary batteries were manufactured in the same manner as in Example 1, except that the prepared electrolytes were used.

Each of the manufactured batteries (E5-1 to E5-8) was charged at a current of 910 mA and 1.0 C/4.2 V (cut-off 0.02 C) under conditions of CC/CV and discharged at a current of 910 mA and a CC of 1.0 C until voltage reached 2.7 V. Lifespan (cycle performance) of each battery was measured by repeating this process 100 times.

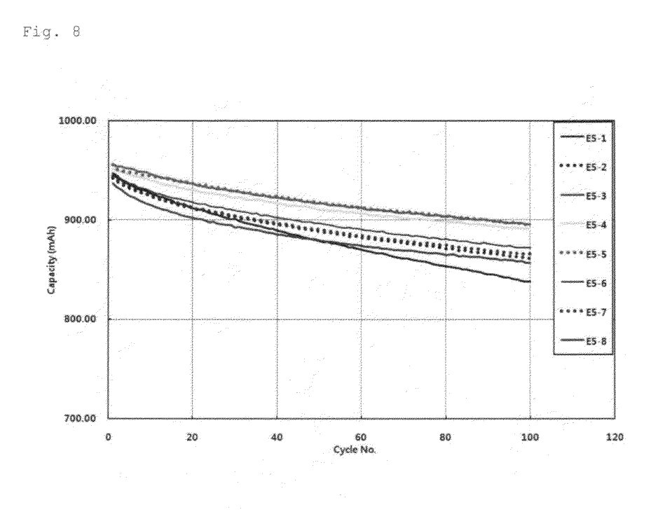

The cycle performance of each battery was evaluated at high temperature (60° C.) and evaluation results are shown in Table 6 below and FIG. 8.

TABLE 6

| Lifespan at | | | 1^{st} | 100^{th} | Effi- |
|---|---|---|---|---|---|
| high | Battery | Additive | cycle | cycle | ciency |
| temperature | No. | (Amount) | (mAh) | (mAh) | (%) |
| | E5-1 | — | 945.3 | 866.3 | 91.6 |
| | E5-2 | FEC (1%) | 937.7 | 864.1 | 92.2 |
| | E5-3 | Propylene sulfide | 944.6 | 873.9 | 92.5 |
| | | (0.5%) + FEC (1%) | | | |
| | E5-4 | Propylene sulfide | 934.8 | 869.1 | 93.0 |
| | | (1.0%) + FEC (1%) | | | |
| | E5-5 | Propylene sulfide | 897.0 | 870.1 | 97.0 |
| | | (2.0%) + FEC (1%) | | | |
| | E5-6 | 1,3-propanediol | 930.7 | 876.2 | 94.1 |
| | | cyclicsulfate | | | |
| | | (0.5%) + FEC (1%) | | | |
| | E5-7 | 1,3-propanediol | 948.1 | 869.5 | 91.7 |
| | | cyclicsulfate | | | |
| | | (1.0%) + FEC (1%) | | | |
| | E5-8 | LiBOB (0.2%) + | 940.3 | 868.1 | 92.3 |
| | | propenesultone | | | |
| | | (1.0%) + FEC (1%) | | | |

Referring to Table 6, it can be confirmed that the batteries (E5-3 to E5-5) of Examples including additives of the present invention have higher efficiency than that of the battery (E5-1) excluding an additive and the batteries (E5-2, E5-6, E5-7, and E5-8) including conventional additives.

As is apparent from the above description, an electrolyte for lithium secondary batteries according to the present invention decomposes before an organic solvent included in the electrolyte during discharge of a battery at room and high temperature and thus effectively and stably forms a solid electrolyte interface (SEI) film on a surface of an anode and, accordingly, lithium ions may be easily intercalated into a surface of an electrode. As a result, lifespan at room and high temperature of the battery may be enhanced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An electrolyte for lithium secondary batteries, comprising:
an organic solvent;
a lithium salt mixed with the organic solvent; and
an electrolyte additive mixed with the organic solvent and represented by Formula 1 below: 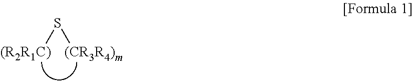
wherein R₁ to R₄ are each independently any one selected from the group consisting of hydrogen, a C₁-C₅ alkyl group, a C₁-C₅ perfluoroalkyl group, a C₃-C₆ cycloalkyl group, a C₂-C₅ alkenyl group, a C₂-C₅ alkynyl group, an allyl group, an alkoxy group, an alkoxyalkyl group, a silyl group, an alkylsilyl group, and a cyano group, and
m is an integer of 1 to 4.

2. The electrolyte according to claim 1, wherein R₁ and R₃ are each independently any one selected from the group consisting of a C₁-C₅ alkanediyl group and a C₁-C₅ alkenediyl group, and R₁ and R₃ are linked to each other to form a four- to ten-membered alicyclic ring.

3. The electrolyte according to claim 1, wherein the electrolyte additive is any one selected from the group consisting of ethylene sulfide, propylene sulfide, 2-vinylthiirane, 2,3-epithiopropyl methyl ether, 2-(trimethylsilyl)-thiirane, 2,3-di(trimethylsilyl)-thiirane, 1-cyano-3,4-epithiobutane, isobutylene sulfide, cyclohexene sulfide, and mixtures thereof.

4. The electrolyte according to claim 1, wherein an amount of the electrolyte additive is 0.1 wt % to 5 wt % based on a total weight of the electrolyte.

5. The electrolyte according to claim 1, wherein the organic solvent is any one selected from the group consisting of ethylene carbonate (EC), propylene carbonate (PC), ethyl methyl carbonate (EMC), dimethyl carbonate (DMC), diethyl carbonate (DEC), fluoroethylene carbonate (FEC), methyl propyl carbonate (MPC), ethyl propyl carbonate (EPC), methyl ethyl carbonate (MEC), butylene carbonate (BC), ethyl acetate, methyl acetate, propyl acetate, ethyl propionate, methyl propionate, propyl propionate, and mixtures thereof.

6. The electrolyte according to claim 1, wherein the lithium salt is any one selected from the group consisting of LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiN(CₓF₂ₓ₊₁SO₂)(C_{y}F_{2y+1}SO₂) where x and y are natural numbers, LiCl, LiI, and mixtures thereof.

7. The electrolyte according to claim 1, further comprising any one additive selected from the group consisting of vinylene carbonate, 1,3-propanesultone, metal fluorides, glutaronitrile, succinonitrile, adiponitrile, 3,3′-thiodipropiodinitrile, propene sultone, lithium bis(oxalato)borate, vinylethylene carbonate, and mixtures thereof.

8. A lithium secondary battery comprising:
a cathode comprising a cathode active material;
an anode comprising an anode active material and facing the cathode; and
the electrolyte according to claim 1 disposed between the cathode and the anode.
